(19) United States
(12) Patent Application Publication
(10) Pub. No.: US 2017/0081243 A1
(43) Pub. Date: Mar. 23, 2017

(54) METHOD FOR MOLDING GLASS

(71) Applicant: SAMSUNG DISPLAY CO., LTD., Yongin-si (KR)

(72) Inventors: Myung-hwan Kim, Seongnam-si (KR); Ikhyung Park, Suwon-si (KR)

(21) Appl. No.: 15/170,800

(22) Filed: Jun. 1, 2016

(30) Foreign Application Priority Data
Sep. 22, 2015 (KR) 10-2015-0134058

(51) Int. Cl. C03C 21/00; C03B 25/02; C03B 23/03

(52) U.S. Cl. CPC C03C 21/002; C03B 23/03; C03B 25/025

(57) ABSTRACT

A method for molding glass, the method includes inserting glass into a chamber housing an upper plate, a lower plate facing the upper plate, and a heat radiation part that is configured to generate heat, placing the glass on the lower plate, moving the upper plate downward to press the glass, thereby molding the glass, applying heat to the glass, withdrawing the glass from the chamber, and forming a reinforcement layer at a surface of the glass by dipping the glass into a solution.

### CROSS-REFERENCE TO RELATED APPLICATION

This application claims priority to, and the benefit of, Korean Patent Application No. 10-2015-0134058, filed on Sep. 22, 2015, the entire contents of which are incorporated herein by reference in their entirety.

### BACKGROUND

1. Field

The present disclosure herein relates to an apparatus and a method for molding glass having a curvature.

2. Description of the Related Art

In general, plastic, such as acryl, has previously been used for forming a window cover used for a display window of a mobile device, such as a mobile phone. However, as smart phone markets have expanded, touch functions, wear resistance, light transmittance, high dielectric constant, and the like have also expanded or improved. Thus, chemically tempered glass is primarily used. Materials for the chemically tempered window include a soda-lime based plate glass, which is for general products, and Gorilla Glass® (Gorilla Glass® is a registered trademark of Corning Incorporated, a New York corporation in the U.S.A.), which is mainly used for high end products.

Glass material is increasingly used in various industrial fields, including use in covers of solar batteries, in flat displays, such as thin film transistor-liquid crystal displays (TFT-LCD), plasma display panels, and organic electroluminescent (EL) displays, and in covers for various mobile electronic devices. Thus, weight reduction and slimming of glass material may be desired.

However, due to brittleness of glass material, achieving safety while also achieving weight reduction and slimming may be challenging. Accordingly, various reinforcing methods are researched for securing the safety of glass. A thermal reinforcing method and a chemical reinforcing method are used for tempering glass.

Thermal reinforcement is a method in which a surface of the glass is heated at a high temperature, and then quenched, thereby generating compressive stress on the surface of the glass to strengthen the glass. However, when thermal reinforcement is performed, it may be difficult to uniformly transfer heat to the whole region of the glass due to the quick heating. As a result, the glass may be locally reinforced with different strengths. In addition, after the thermal reinforcement, the waviness and light transmittance of the glass are reduced, and the refractive index of the glass may be non-uniform.

### SUMMARY

The present disclosure provides a method for molding glass for a flexible display by using thicker glass while equally maintaining a level of a curvature.

An embodiment of the inventive concept provides a method for molding glass, the method includes inserting glass into a chamber housing an upper plate, a lower plate facing the upper plate, and a heat radiation part that is configured to generate heat, placing the glass on the lower plate, moving the upper plate downward to press the glass, thereby molding the glass, applying heat to the glass, withdrawing the glass from the chamber, and forming a reinforcement layer at a surface of the glass by dipping the glass into a solution.

The lower plate may include a convex top surface, and the upper plate may include a concave bottom surface that may be curved in a first direction.

The glass may include molding the glass to include a curved shape that may be curved in the first direction.

The heat to the glass may reduce stress of the glass.

The heat may have a temperature of about 400° C. to about 900° C.

The solution may include a potassium-nitrate solution.

A surface of the glass may include first ions, and the solution may include second ions.

The forming of the reinforcement layer at the surface of the glass may include heating the solution, and may include exchanging the first ions with the second ions.

The first ions may include sodium ions.

The second ions may include potassium ions.

The forming of the reinforcement layer at the surface of the glass may include depositing the second ions at the surface of the glass.

The upper plate may include a supporting plate having a flat shape, and a pressing part below the supporting plate, and may include a first curvature, and the lower plate may include a molding member facing the pressing part, and may include a convex shape corresponding to the first curvature, and an accommodating member defining a groove to insert the molding member.

The glass may be configured to be placed between the molding member and the pressing part.

The molding of the glass may include supporting a bottom surface of the glass with the molding part, and may include pressing a top surface of the glass with the pressing part.

The glass may include molding the glass to have a shape corresponding to the first curvature.

### BRIEF DESCRIPTION OF THE DRAWINGS

The accompanying drawings are included to provide a further understanding of embodiments of the inventive concept, and are incorporated in, and constitute a part of, this specification. The drawings illustrate embodiments of the inventive concept and, together with the description, serve to explain aspects of embodiments of the inventive concept. In the drawings:

FIG. 1 is a perspective view of a mechanism for molding glass according to an embodiment of the present invention;

FIG. 2 is a view illustrating a lower plate of a glass molding mechanism according to an embodiment of the present invention;

FIG. 3 is a view of glass between plates according to an embodiment of the present invention;

FIG. 4 is a view illustrating a method for molding the glass according to an embodiment of the present invention;

FIG. 5 is a view illustrating a method for heat-treating the glass according to an embodiment of the present invention;

FIG. 6 is a view illustrating a method for chemically tempering the glass according to an embodiment of the present invention;

FIG. 7 is a view of dipped glass according to an embodiment of the present invention;

FIG. 8 is an enlarged view of a surface of the ion-exchanging glass in FIG. 7;

FIG. 9 is a view illustrating an ion arrangement of the glass that is ion-exchanged according to an embodiment of the present invention; and

FIG. 10 is a view of the molded glass according to an embodiment of the present invention.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section.

Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

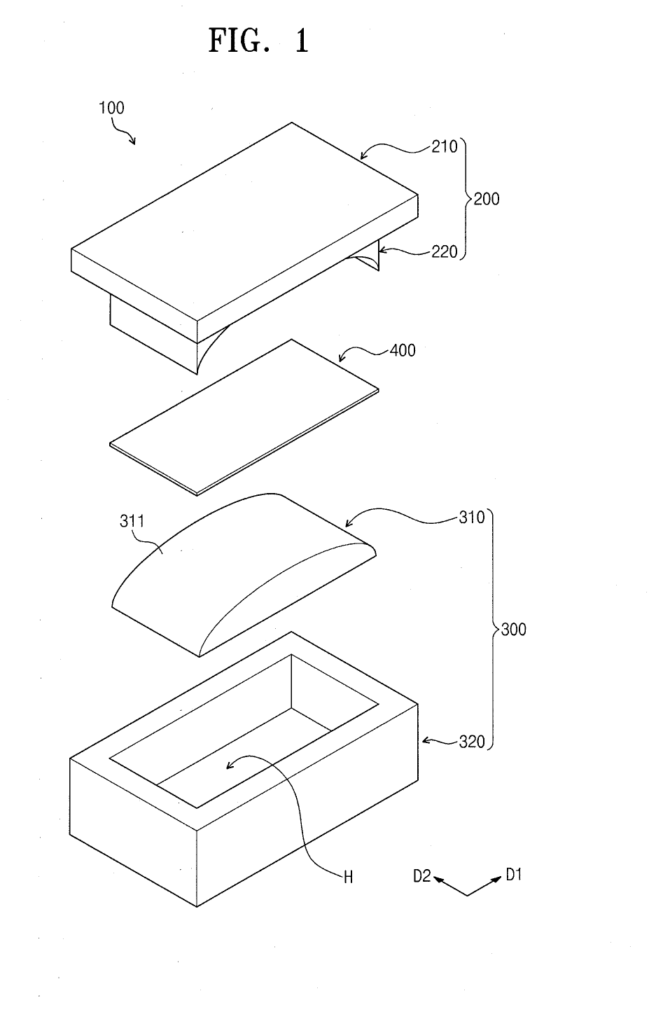

FIG. 1 is a perspective view of a mechanism for molding glass according to an embodiment of the present invention.

Referring to FIG. 1, according to an embodiment of the inventive concept, a mechanism 100 for molding glass having a curvature (e.g., a predetermined curvature) (hereinafter, referred to as a molding mechanism 100) includes an upper plate 200 and a lower plate 300, and glass 400 is placed between the upper plate 200 and the lower plate 300.

The glass 400 is between the upper plate 200 and the lower plate 300. The glass 400 extends lengthwise (e.g., has a long side) in a first direction D1, and has a width (e.g., a short side) in a second direction D2 crossing the first direction D1. The glass 400 may have a flat shape prior to being molded by the molding mechanism 100.

The glass 400 may have a radius of curvature in a range of about 1 mm to about 20 mm, and may have a thickness in a range of about 20 μm to about 200 μm.

When the curvature and thickness of the glass 400 are below the abovementioned ranges, the substrate might not be strong enough to support a display device or the like. When the curvature and thickness of the glass 400 are above the abovementioned ranges, the substrate might not be flexible because the substrate is too thick.

When the glass 400 is molded by the molding mechanism 100, the glass 400 may be molded to have a curved surface (e.g., a surface having a predetermined curvature) in the first direction D1, and to have a flat shape (e.g., to be uncurved) in the second direction D2.

The upper and lower plates 200, 300 of the molding mechanism 100 may be made of metal. Although the molding mechanism 100 according to an embodiment of the present invention is a mold that is formed of graphite, the present invention is not limited thereto. As a non-limiting example, the molding mechanism 100 may be made of ceramic, tungsten carbide (WC), silicon carbide (SiC), or the like.

The upper plate 200 may be used for pressing the glass 400 so that the glass 400 is molded to have a curved surface. The upper plate 200 has a long side (e.g., extends lengthwise) in the first direction D1, and has a short side (e.g., extends widthwise) in the second direction D2. The upper plate 200 may include a supporting plate 210 having a flat shape, and may include a pressing part 220 below the supporting plate 210.

The supporting plate 210 and the pressing part 220 may each have a long side in the first direction D1, and a short side in the second direction D2.

The pressing part 220 may be configured to be placed on the glass 400, and the upper plate 200 may move downward to allow the pressing part 220 to press the glass 400. The pressing part 220 is above the glass 400, and has a first curvature that may be bent in the first direction D1 (e.g., a first curvature that bends along the first direction D1).

When the upper plate 200 moves downward to press the glass 400, the pressing part 220 may contact a top surface of the glass 400, and a bottom surface of the glass 400 may contact an upper portion of a molding member 310 of the lower plate 300, which also has the first curvature (e.g., has a shape corresponding to the first curvature).

The lower plate 300 may include the molding member 310 on which the glass 400 is located, and may also include an accommodating member 320 configured to accommodate the molding member 310. The glass 400 may be located on the molding member 310. The accommodating member 320 may include a groove H recessed downward from a top surface of the accommodating member 320, and the molding member 310 may be inserted into, and fixed within, the groove H.

A top surface of the molding member 310 and a bottom surface of the pressing part 220 may face each other, and the top surface of the molding member 310 may have the same shape as (e.g., may correspond to the shape of) the bottom surface of the pressing part 220.

The lower plate 300 may include the molding member 310 configured to correspond to the pressing part 220, and the molding member 310 may include a molding part (e.g., a surface of the molding member 310) 311 having a convex shape having the same curvature as (e.g., corresponding to the curvature of) the pressing part 220.

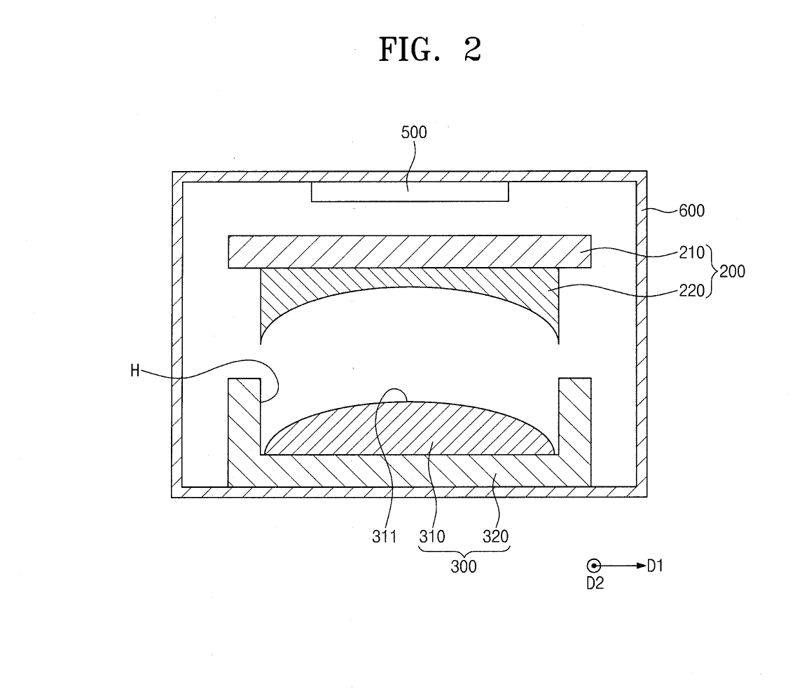

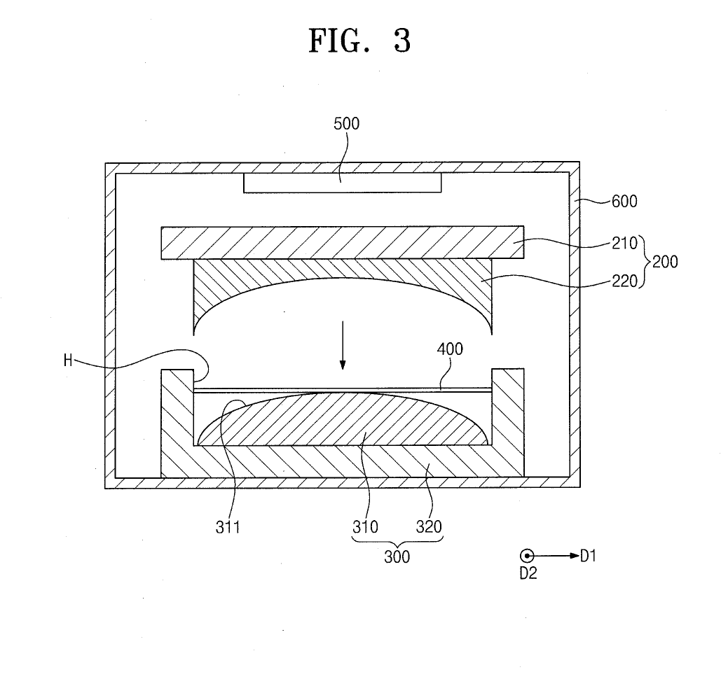

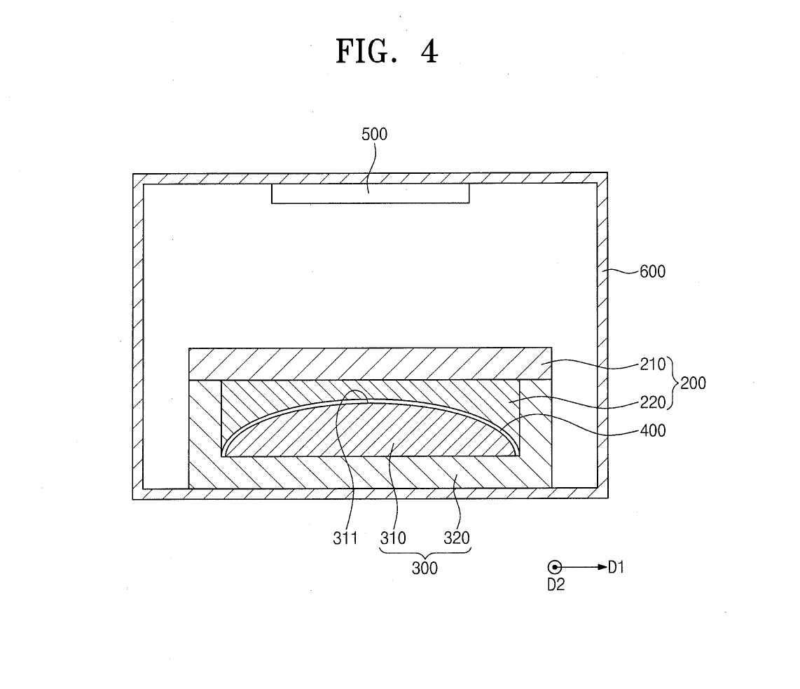

FIGS. 2 to 4 are views illustrating a method for molding glass according to an embodiment of the present invention. FIG. 2 is a view illustrating a lower plate of a glass molding mechanism, FIG. 3 is a view of the glass located between the plates, and FIG. 4 is a view illustrating the method for molding glass.

In describing FIGS. 2 to 4, reference symbols for above-described components are given, and overlapped description for the components will be omitted.

Referring to FIG. 2, the molding mechanism 100 is in a chamber 600, and the upper plate 200 and the lower plate 300 face each other. The molding member 310 may be inserted into the groove H of the accommodating member 320.

The chamber 600 may include a vacuum pump for maintaining a vacuum state in the chamber 600. The vacuum pump may be connected to the chamber 600 to adjust a pressure in the chamber 600, thereby making a high vacuum environment in the chamber 600. The vacuum pump may be connected to the outside of the chamber 600 having the high vacuum environment to discharge air in the chamber 600 to the outside.

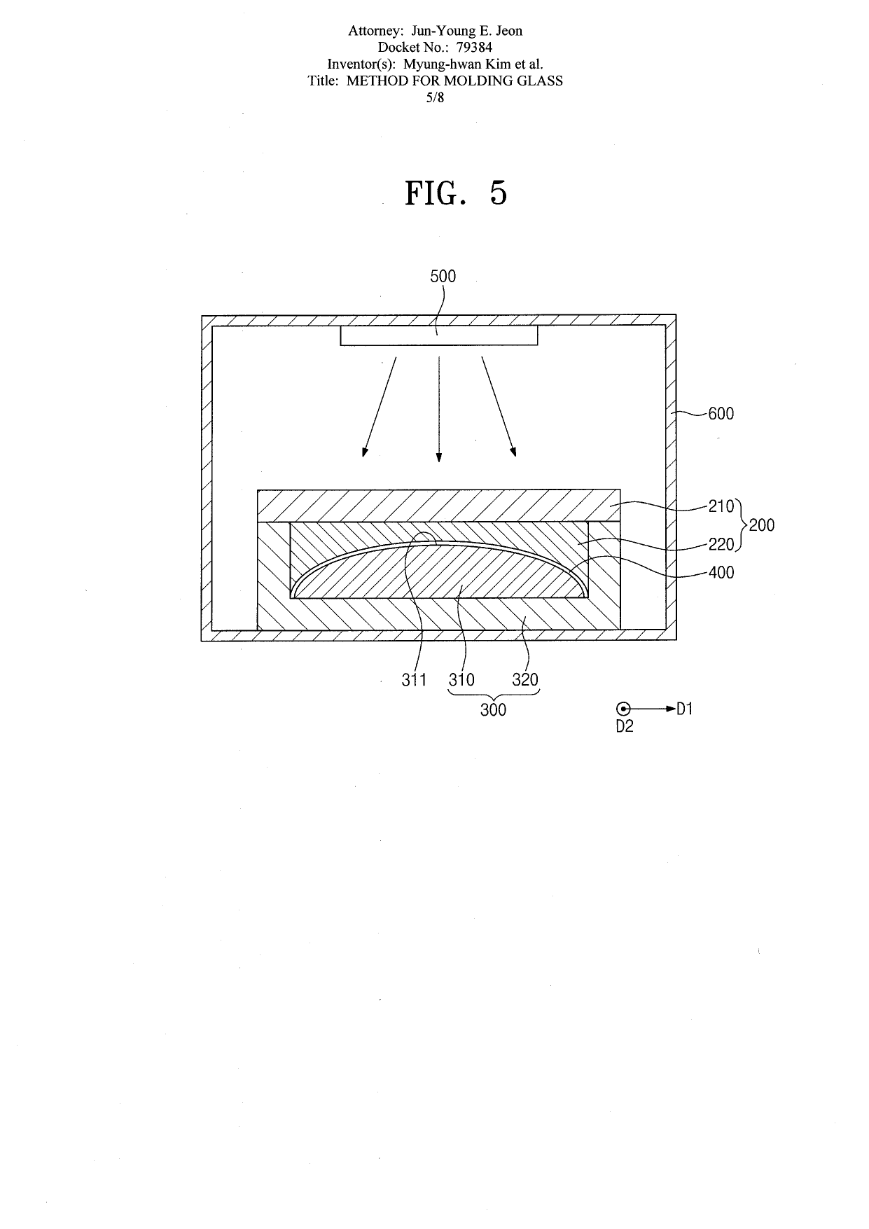

A heat radiation part 500 for heating the molding mechanism 100 is in the chamber 600. A constitution in which the heat radiation part 500 heats the molding mechanism 100 will be described in detail with reference to FIG. 5.

Referring to FIG. 3, the glass 400 may be placed on the molding member 310, and a side surface of the glass 400 may contact an area (e.g., a predetermined area) of an upper portion of an inner surface of the accommodating member 320 in the groove H.

The glass 400 may be inserted into the chamber 600 from the outside through a gate of the chamber 600, and may be located on the molding member 310.

The upper plate 200 may move downward to press the glass 400 on the molding member 310.

Referring to FIG. 4, the upper plate 200 may move downward to contact the top surface of the glass 400, and to then press the glass 400.

The glass 400 may be molded to have a curved surface having the same curvature as (e.g., corresponding to the curvature of) the molding member 310. That is, when viewed from the second direction D2, the glass 400 may have a cross-section having a curved shape.

The molding member 310 may face the upper plate 200, and may contact a bottom surface of the glass 400 to support the glass 400. Accordingly, the glass 400 on the lower plate 300 may be pressed by the upper plate 200 to form a curved surface.

The molding member 310 may be located in the groove H defined by the lower plate 300. That is, side and bottom surfaces of the molding member 310, to the exclusion of the top surface of the molding member 310, may respectively contact inner and bottom surfaces of the groove H.

The flat glass 400 may be on the top surface of the molding member 310. Both side surfaces of the glass 400 may contact the inner surface of the accommodating member 320 of the lower plate 300 in the groove H. The top surface of the molding member 310 may have substantially the same height as the top surface of the glass 400 after the molding.

The upper plate 200 may be on the glass 400, and the upper plate 200 may move downward to press the glass 400. The pressing part 220 on a bottom surface of the upper plate 200 may press the glass 400 against the molding member 310. That is, the pressing part 220 may press the glass 400 so that the glass 400 is molded to have substantially the same curvature shape as the pressing part 220.

FIG. 5 is a view illustrating a method for heat-treating the glass according to an embodiment of the present invention. In describing FIGS. 4 and 5, reference symbols for above-described components are given, and overlapped or repeated description for the components will be omitted.

Referring to FIG. 5, the glass 400 between the lower and upper plates 300 and 200, which are described in FIGS. 2 and 4, may be molded to have the curved surface in the chamber 600, in which the upper plate 200, the lower plate 300 facing the upper plate 200, and the heat radiation part 500 for generating heat may be located. Thereafter, the heat radiation part 500 in the chamber 600 may generate heat.

The upper and lower plates 200, 300 are heated, and the heat is transferred to the glass 400 by the plates 200, 300. As a result, the heat may be applied to the glass 400.

The heat radiation part 500 may generate heat having a temperature of about 400° C. to about 900° C. When molded to have a curved surface, a resistance force may be generated in the glass 400 to correspond to a pressure applied by the plates 200, 300. Herein, resistance force may be defined as stress. Due to the stress, the curved portion of the glass 400 may be damaged.

When the heat is applied to the glass 400, the stress generated in the glass 400 may be reduced or relieved. As a result, the damage of the glass 400 caused by the stress may be avoided.

Also, because the thermal process is performed in a state in which the glass is fixed in the closed chamber 600, even in a large sized glass, temperature distribution may be uniform over the glass 400, and a thermal deformation of the glass 400 may be reduced or minimized.

The heat radiation part 500 may include a control part for adjusting thermal temperature and time. When the glass 400 is heat-treated, the glass 400 may be heated (e.g., heated to a predetermined temperature) by the heat radiation part 500, and may be maintained at the temperature for an amount time. The heat radiation part 500 may include a heater.

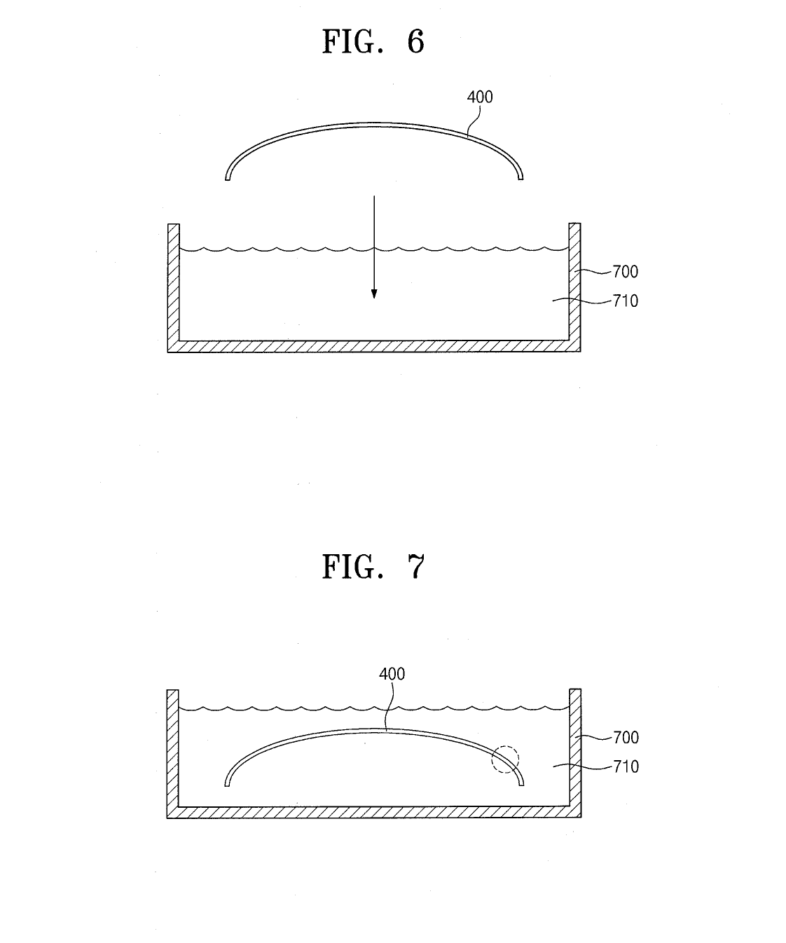

FIGS. 6 to 7 are views illustrating a method for chemically tempering the glass according to an embodiment of the present invention. In describing FIGS. 6 to 7, reference symbols for above-described components are given, and overlapped or repeated description for the components will be omitted.

Referring to FIGS. 6 and 7, first and second portions of the glass 400 may be molded such that the glass 400 has a curved surface, and then the heat-treated glass 400 may be withdrawn through the gate of the chamber 600. A storage bath 700, in which a solution 710 for dipping the withdrawn glass 400, may be prepared. The glass 400 may be dipped into the solution 710 in the storage bath 700.

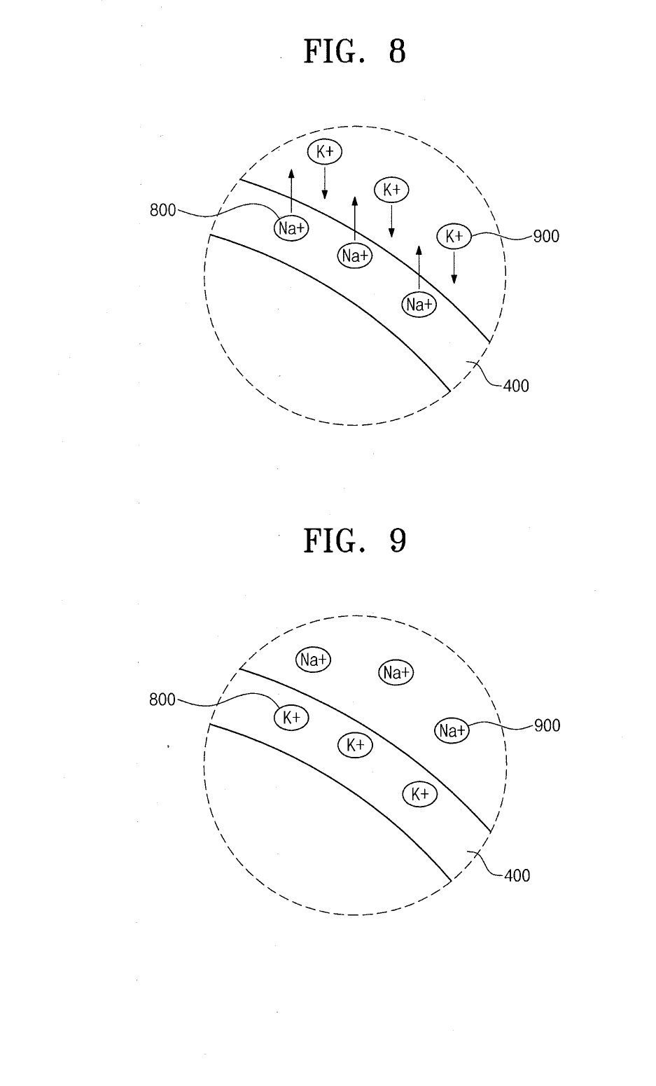

The solution 710 may include potassium nitrate (KNO₃). First ions 800 (see FIG. 8) exist on the surface of the glass 400, and the solution 710 may include second ions 900 (see FIG. 8). The first ions 800 may be sodium ions (Na⁺), and the second ions 900 may be potassium (K⁺) ions.

Hereinafter, the solution 710 is defined as a potassium nitrate solution 710. The solution 710 is heated (e.g., heated to a predetermined temperature) to form a reinforcement layer on the surface of the glass 400. A heating part for heating the solution 710 may be in the storage bath 700.

As a result of heating the solution 710 in which the glass 400 is dipped, a process of ion exchange that exchanges the first ions 800 at the surface of the glass 400 dipped in the solution 710 with the second ions 900 dipped in the solution 710. Through the ion exchange, compressive stress may be formed on the surface of the glass 400 to temper the glass 400. The glass tempering method may be referred to as a chemical reinforcement.

The ion exchange is a reaction in which ions of an insoluble solid may be reversibly exchanged with other ions having the same sign (e.g., the ions of the insoluble solid and the other ions may both be positively charged or may both be negatively charged) as each other. For example, the ion exchange is exchanging one kind of ions that exist on a surface of a mineral contacting water, or on other positions, with another kind of ions that are dissolved in the water. Positive ions between the mineral and the solution may include calcium (Ca²⁺), magnesium (Mg²⁺), sodium (Na⁺), and potassium (K⁺).

Accordingly, the reinforcement layer may be formed on the surface of the glass 400 by the solution 710.

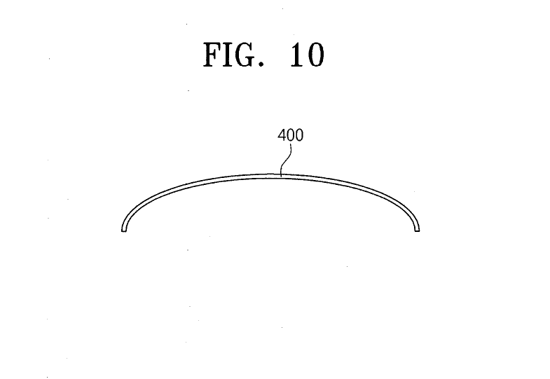

Hereinafter, a constitution in which the reinforcement layer is formed on the glass 400 will be described in detail with reference to FIGS. 8 to 10. FIGS. 8 to 10 are views illustrating a method for exchanging ions of the glass according to an embodiment of the present invention. FIG. 8 is an enlarged view illustrating the surface, in which ions are exchanged, of the glass shown in FIG. 7, FIG. 9 is a view illustrating an ion arrangement of the ion-exchanged glass, and FIG. 10 is a view of a molded glass. In describing FIGS. 8 to 10, reference symbols for above-described components are given, and overlapped description for the components will be omitted.

Referring to FIGS. 8 to 10, the glass may be dipped into the heated solution 710, and the first ions 800 existing on the surface of the glass 400 may escape from the surface of the glass 400. The second ions 900 of the solution 710 permeate into the surface of the glass 400, from which the first ions 800 are removed. That is, some of the second ions 900 may replace the first ions 800.

Although potassium ions, as the second ions 900, each have a radius that is greater than that of sodium ions, as the first ions 800. Accordingly, when the sodium ions 800 and the potassium ions 900 are ion-exchanged, the surface of the glass 400 may increase in strength. It should be noted that the method for chemical tempering the glass is not limited thereto.

As a non-limiting example, microwaves may be emitted to the glass 400 to vibrate sodium ions 800 of the glass 400, thereby loosening molecular binding structure of the glass 400, and thereby generating heat caused by the vibration. Also, the potassium ions 900 in the solution 710 may react to the microwave to vibrate the glass 400, and thus ion activity of the solution 710 may increase, and heat caused by the vibration may be generated.

The glass 400 that is chemically tempered and heat-treated may have compressive stress that is greater than that of the glass 400 if it were not heat-treated.

According to an embodiment of the present invention, the method for molding glass may apply the heat to the glass molded to have the curved surface to relieve the stress of the glass.

Also, through the exchanging of ions, the compressive stress may be formed on the surface of the glass to temper the surface of the glass.

It will be apparent to those skilled in the art that various modifications and variations can be made in the inventive concept. Thus, it is intended that the present disclosure covers the modifications and variations of this invention provided they come within the scope of the appended claims and their equivalents. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for molding glass, the method comprising:
inserting glass into a chamber housing an upper plate, a lower plate facing the upper plate, and a heat radiation part that is configured to generate heat;
placing the glass on the lower plate;
moving the upper plate downward to press the glass, thereby molding the glass;
applying heat to the glass;
withdrawing the glass from the chamber; and
forming a reinforcement layer at a surface of the glass by dipping the glass into a solution.

2. The method of claim 1, wherein the lower plate comprises a convex top surface, and
wherein the upper plate comprises a concave bottom surface that is curved in a first direction.

3. The method of claim 2, wherein molding the glass comprises molding the glass to comprise a curved shape that is curved in the first direction.

4. The method of claim 1, wherein applying the heat to the glass reduces stress of the glass.

5. The method of claim 1, wherein the heat has a temperature of about 400° C. to about 900° C.

6. The method of claim 1, wherein the solution comprises a potassium-nitrate solution.

7. The method of claim 1, wherein a surface of the glass comprises first ions, and
wherein the solution comprises second ions.

8. The method of claim 7, wherein the forming of the reinforcement layer at the surface of the glass comprises:
heating the solution; and
exchanging the first ions with the second ions.

9. The method of claim 8, wherein the first ions comprise sodium ions.

10. The method of claim 8, wherein the second ions comprise potassium ions.

11. The method of claim 8, wherein the forming of the reinforcement layer at the surface of the glass comprises depositing the second ions at the surface of the glass.

12. The method of claim 1, wherein the upper plate comprises:
a supporting plate having a flat shape; and
a pressing part below the supporting plate, and comprising a first curvature, and
wherein the lower plate comprises:
a molding member facing the pressing part, and comprising a convex shape corresponding to the first curvature; and
an accommodating member defining a groove to insert the molding member.

13. The method of claim 12, wherein the glass is configured to be placed between the molding member and the pressing part.

14. The method of claim 13, wherein the molding of the glass comprises:
supporting a bottom surface of the glass with the molding part; and
pressing a top surface of the glass with the pressing part.

15. The method of claim 14, wherein molding the glass comprises molding the glass to have a shape corresponding to the first curvature.
